(19) United States
(12) Patent Application Publication
(10) Pub. No.: US 2006/0171721 A1
(43) Pub. Date: Aug. 3, 2006

(54) Label remover and label swapper using the same

(75) Inventors: Sung-Kee Kim, Suwon-si (KR); Hoon Kim, Suwon-si (KR); Yun-Je Oh, Yongin-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/185,108

(22) Filed: Jul. 20, 2005

(30) Foreign Application Priority Data
Jan. 28, 2005 (KR) 2005-8179

(51) Int. Cl. H04B 10/04

(52) U.S. Cl. 398/187

(57) ABSTRACT

A label remover, and the method using the same, renders photoelectric conversion becomes unnecessary and improves using conditions and transmission quality. The label remover includes: (a) an oscillator for outputting a driving signal having a third frequency f3; (b) a double-sided band converter for (i) receiving an optical signal modulated based on a data signal of an intermediate frequency fm and frequency-modulated based on a label signal so as to indicate a first frequency f1 and a second frequency f2; and (ii) frequency-transiting the received optical signal so that each of the first and second frequencies is transited to at least two frequencies including the intermediate frequency fm; and (c) a band passer filter for filtering the frequency-transited optical signal to remove frequencies except the intermediate frequency fm.

### CLAIM OF PRIORITY

This application claims priority under 35 U.S.C. § 119 to an application entitled “Label Remover and Label Swapper Using the Same”, filed in the Korean Intellectual Property Office on Jan. 28, 2005 and assigned Ser. No. 2005-8179, the contents of which are incorporated herein by reference.

### BACKGROUND OF THE INVENTION

1. Field of the Invention

The present invention relates to an optical network system using labels, and more particularly, to a method of performing label swapping or label switching of an optical signal transmitted through the optical network system.

2. Description of the Related Art

Technology using labels in an optical network system having a plurality of nodes is known. Each intermediate node in the optical network system must simultaneously perform the process of reading a label for each input packet and replacing it with a new label, a label swapping process. One of known multi-protocol label switching (MPLS) techniques performs the on-off keying (OOK) modulation of an optical signal based on payload data and frequency shift keying (FSK) modulation of the OOK-modulated optical signal based on label data for routing the optical signal at a lower frequency. In this case, each intermediate node must perform complex processes of converting an input optical signal to an electrical signal, swapping labels, and converting the label-swapped electrical signal to an optical signal again.

To solve this problem, technology of installing an all-optical label swapper to each intermediate node is used. The all-optical label swapper removes a label from an optical signal using a cross phase modulation (XPM) effect and cross gain modulation (XGM) effect of a semiconductor optical amplifier (SOA), then performs the FSK modulation of the label-removed optical signal using a four wave mixing (FWM) effect of the SOA.

However, the all-optical label swapper uses non-linear effects, such as the FWM, XPM and XGM, and the efficiency of such effects is poor. Accordingly, transmission quality is deteriorates. In addition, since an extinction ratio, intensity, and a wavelength of an input signal related to non-linear effects of the SOA are limited, the conditions for using the all-optical label swapper are complicated.

### SUMMARY OF THE INVENTION

The present invention provides a label removing method in which photoelectric conversion is unnecessary and improves working conditions and transmission quality, and a label swapping method using the same.

One aspect of the present invention provides a label removing method comprising the steps of: (a) receiving an optical signal modulated based on a data signal of an intermediate frequency fm and frequency-modulated based on a label signal so as to indicate a first frequency f1 and a second frequency f2; (b) frequency-transiting the received optical signal so that each of the first and second frequencies is transited to at least two frequencies including the intermediate frequency fm; and (c) filtering the frequency-transited optical signal to remove frequencies except the intermediate frequency fm.

Another aspect of the present invention provides a label swapping method comprising the steps of: (a) receiving an optical signal modulated based on a data signal of an intermediate frequency and frequency-modulated based on a label signal so as to indicate a first frequency f1 and a second frequency f2; (b) frequency-transiting the received optical signal so that each of the first and second frequencies is transited to at least two frequencies including the intermediate frequency; (c) filtering the frequency-transited optical signal to remove frequencies except the intermediate frequency; and (d) modulating the filtered optical signal based on the data signal of the intermediate frequency and frequency-modulating the modulated optical signal based on the label signal so as to indicate the first frequency f1 or the second frequency f2.

### BRIEF DESCRIPTION OF THE DRAWINGS

The features of the present invention will become more apparent from the following detailed description in conjunction with the accompanying drawings in which:

FIG. 1 is a block diagram of an optical network system using labels according to an embodiment of the present invention;

FIG. 2 is a block diagram of a label swapper shown in FIG. 1;

FIGS. 3A to 3C are diagrams illustrating signals processed by a starting node shown in FIG. 1; and

FIGS. 4A to 4E are diagrams illustrating signals processed by a label remover shown in FIG. 2.

### DETAILED DESCRIPTION

Hereinafter, embodiments of the present invention will be described with reference to the accompanying drawings. In the drawings, the same or similar elements are denoted by the same reference numerals even though they are depicted in different drawings. For the purposes of clarity and simplicity, well-known functions or constructions are not described in detail as they would obscure the invention in unnecessary detail.

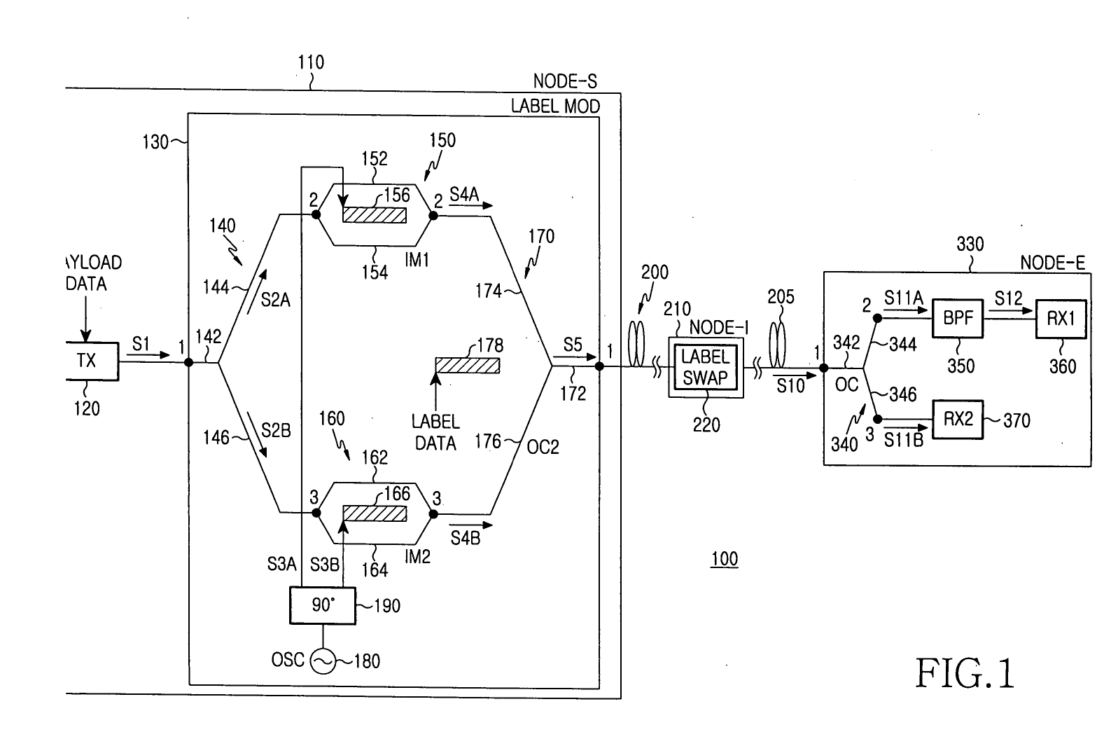

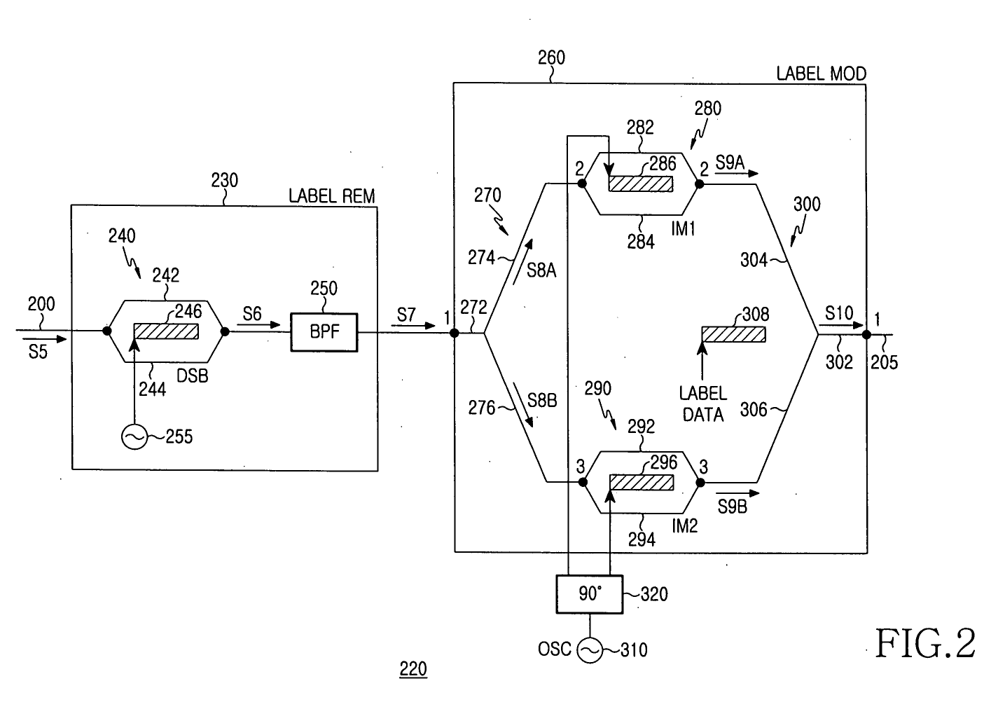

FIG. 1 is a block diagram of an optical network system 100 using labels according to an embodiment of the present invention. FIG. 2 is a block diagram of a label swapper 220 shown in FIG. 1. The optical network system 100 includes a starting node (NODE-S) 110, at least one intermediate node (NODE-I) 210 and an end node (NODE-E) 330. The NODE-S 110, NODE-I 210 and NODE-E 330 are connected to each other through optical fibers 200 and 205.

The NODE-S 110 includes an optical transmitter (TX) 120 and a label modulator (LABEL MOD) 130.

The TX 120, which outputs an OOK-modulated optical signal S1 based on payload data of an intermediate frequency fm, may include a typical laser diode. That is, the OOK-modulated optical signal S1 represents every “1” bit of the payload data as a power of an “A” level and every “0” bit of the payload data as a power of a “B” level. This OOK modulation scheme is one of intensity modulation schemes. The optical signal output from the TX 120 can be arbitrary-non-frequency-modulated signal based on the payload data, and this non-frequency modulation scheme includes the intensity modulation schemes and polarization modulation schemes. The intermediate frequency fm corresponds to a mean frequency (f1+f2)/2 of separated first and second frequencies f1 and f2.

The LABEL MOD 130, which performs FSK modulation of the OOK-modulated optical signal S1 based on label data, includes first and second optical couplers (OCs) 140 and 170, an oscillator (OSC) 180, a 90° hybrid coupler 190 and first and second intensity modulators (IMs) 150 and 160.

The first OC 140 includes a root waveguide 142 and coupled to first and second branch waveguides 144 and 146 that branch off in two directions from the root waveguide 142 and first to third ports. The first port is connected to the TX 120, the second port is connected to the first IM 150, and the third port is connected to the second IM 160. The first OC 140 power-splits the OOK-modulated optical signal S1 input through the first port (generates first and second split optical signals S2A and S2B) and outputs the power-split first and second split optical signals S2A and S2B to the second and third ports, respectively. The first OC 140 may be a typical Y-branch waveguide.

The OSC 180 outputs a sinusoidal wave electrical signal having a predetermined frequency and controls a frequency difference between the first and second frequencies f1 and f2, which are output frequencies of the LABEL MOD 130, by controlling the predetermined frequency.

The 90° hybrid coupler 190 generates first and second driving signals S3A and S3B having a 90° phase difference from the electrical signal input from the OSC 180.

The first IM 150 includes first and second arms 152 and 154 that at coupled to each other at both ends and an electrode 156 for supplying the first driving signal S3A. First end of the first IM 150 is coupled to the second port of the first OC 140 and second end is coupled to a second port of the second OC 170. The first IM 150 inputs the first split optical signal S2A from the first OC 140 and outputs a first intensity-modulated optical signal S4A generated by intensity-modulating the first split optical signal S2A based on the input first driving signal S3A. Each of the first and second IMs 150 and 160 may be a LiNbO₃ MachZehnder modulator.

The second IM 160 includes first and second arms 162 and 164 that are coupled to each other at both ends and an electrode 166 for supplying the second driving signal S3B. First end of the second IM 160 is coupled to the third port of the first OC 140 and a second end is coupled to a third port of the second OC 170. The second IM 160 inputs the second split optical signal S2B from the first OC 140 and outputs a second intensity-modulated optical signal S4B generated by intensity-modulating the second split optical signal S2B based on the input second driving signal S3B.

The second OC 170 includes a root waveguide 172 that are coupled to first and second branch waveguides 174 and 176 that branch off in two directions from the root waveguide 172, an electrode 178, and a first to third ports. The electrode 178 is deployed between the first and second branch waveguides 174 and 176 and provides label data. The first port is coupled to the optical fiber 200, the second port is coupled to the first IM 150, and the third port is coupled to the second IM 160. The second OC 170 controls a phase difference between the first intensity-modulated optical signal S4A passing through the first branch waveguide 174 and the second intensity-modulated optical signal S4B passing through the second branch waveguide 176 based on the label data. Thereafter, the second OC 170 outputs an FSK-modulated optical signal S5 generated by coupling the two phase-controlled optical signals. The label data has a lower frequency than the intermediate frequency fm of the payload data. The FSK-modulated optical signal S5 represents every “1” bit of the label data as the first frequency f1 and every “0” bit of the label data as the second frequency f2. In addition, as described above, since the FSK-modulated optical signal S5 is OOK-simulated, every “1” bit of the payload data is represented as the power of the “A” level and every “0” bit of the payload data is represented as the power of the “B” level.

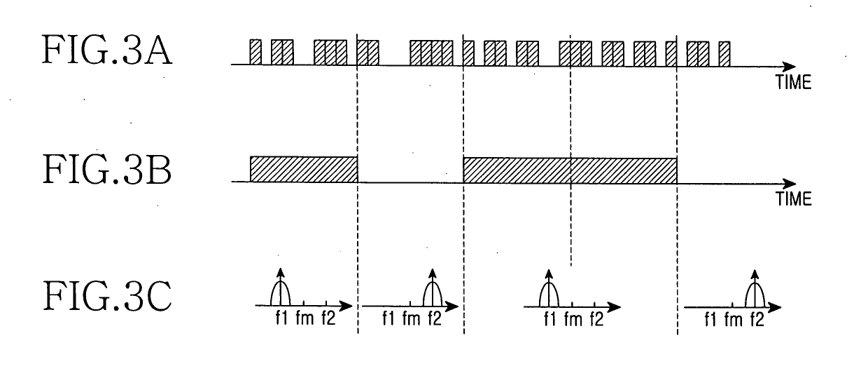

FIGS. 3A to 3C are diagrams illustrating signals processed by the starting node (NODE-S) 110 shown in FIG. 1. FIG. 3A illustrates the payload data input to the TX 120, where the payload data is a bitstream composed of “0” bits and “1” bits. The payload data has the intermediate frequency fm. FIG. 3B illustrates the label data supplied to the second OC 170, where the label data is a bitstream composed of “0” bits and “1” bits. The label data has the lower frequency than the intermediate frequency fm of the payload data. FIG. 3C illustrates a frequency spectrum of the FSK-modulated optical signal S5 output from the LABEL MOD 130. The FSK-modulated optical signal S5 represents every “1” bit of the label data as the first frequency f1 and every “0”bit of the label data as the second frequency f2.

Returning to FIG. 1, the NODE-I 210 includes the label swapper 220. As shown in FIG. 2, the label swapper 220 includes a label remover (LABEL REM) 230 and a label modulator (LABEL MOD) 260.

The LABEL REM 230 in FIG. 2 removes the label data from the FSK-modulated optical signal S5 by removing the first and second frequencies f1 and f2 included in the FSK-modulated optical signal S5 and restoring the intermediate frequency fm. The LABEL REM 230 includes an oscillator (OSC) 255, a double side band converter (DSB) 240 and a band pass filter (BPF) 250.

The OSC 255 outputs a sinusoidal third driving signal having a third frequency f3, which corresponds to a half of difference between the first and second frequencies (f1−f2)/2.

The DSB 240 includes first and second arms 242 and 244 coupled to each other at both ends and an electrode 246 for supplying the third driving signal. A first end of the DSB 240 is also coupled to the optical fiber 200 and a second end is also coupled to the BPF 250. The DSB 240 receives the FSK-modulated optical signal S5 from the optical fiber 200 and receives double-side-band-converts the FSK-modulated optical signal S5 based on the third driving signal from the OSC 255. Accordingly, the first frequency f1 is transited to a frequency (f1−f3) and a frequency (f1+f3), and the second frequency f2 is transited to a frequency (f2−f3) and a frequency (f2+f3). Herein, the frequency (f1+f3), the frequency (f2−f3) and the intermediate frequency fm are identical. That is, the DSB 240 double-side-band-converts the FSK-modulated optical signal S5 having two frequencies to an optical signal S6 having three frequencies. The DSB 240 may be the LiNbO₃ Mach-Zehnder modulator.

The BPF 250 frequency-filters the input double-side-band-converted optical signal S6, where the filtering frequency is set equally to the intermediate frequency fm. That is, the BPF 250 removes the frequencies (f1−f3) and (f2+f3) except the intermediate frequency fm by filtering the double-side-band-converted optical signal S6.

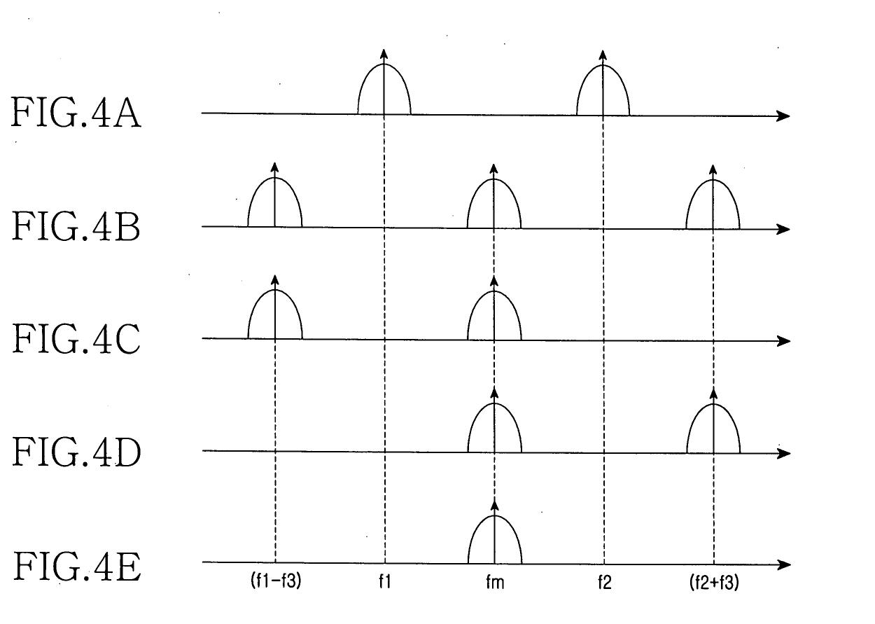

FIGS. 4A to 4E are diagrams illustrating signals processed by the label remover (LABEL REM) 230 shown in FIG. 2. FIG. 4A illustrates a frequency spectrum of the FSK-modulated optical signal S5 input to the DSB 240. As shown in FIG. 4A, the FSK-modulated optical signal S5 has the first and second frequencies f1 and f2. FIG. 4B illustrates a frequency spectrum of the double-side-band-converted optical signal S6 output from the DSB 240. FIG. 4C illustrates a state in which the first frequency f1 is converted to the frequencies (f1−f3) and (f1+f3). FIG. 4D illustrates a state in which the second frequency f2 is converted to the frequencies (f2−f3) and (f2+f3). FIG. 4E illustrates a frequency spectrum of a frequency-filtered (or existing-label-data-removed) optical signal S7 output from the BPF 250.

Returning to FIG. 2, the LABEL MOD 260, which FSK-modulates the frequency-filtered optical signal S7 based on a new label data, includes first and second OC 270 and 300, an OSC 310, a 90° hybrid coupler 320, and first and second IMs 280 and 290. The LABEL MOD 260 has the equal configuration as the LABEL MOD 130 of the NODE-S 110.

The first OC 270, which includes a root waveguide 272 coupled to first and second branch waveguides 274 and 276 that branch off in two directions from the root waveguide 272, and first to third ports. The first port is coupled to the BPF 250, the second port is coupled to the first IM 280, and the third port is coupled to the second IM 290. The first OC 270 power-splits the frequency-filtered optical signal S7 input from the first port (generates first and second split optical signals S8A and S8B) and outputs the power-split first and second split optical signals S8A and S8B to the second and third ports, respectively.

The OSC 310 outputs a sinusoidal electrical signal having a predetermined frequency and controls a frequency difference between the first and second frequencies f1 and f2 by controlling the predetermined frequency. The first and second frequencies f1 and f2 are output frequencies of the LABEL MOD 260.

The 90° hybrid coupler 320 generates first and second driving signals having a 90° phase difference from the electrical signal input from the OSC 310.

The first IM 280 includes first and second arms 282 and 284 coupled to each other at both ends and an electrode 286 for supplying the first driving signal. The first end of the first IM 280 is coupled to the second port of the first OC 270 and the second end is coupled to a second port of the second OC 300. The first IM 280 inputs the first split optical signal S8A from the first OC 270 and outputs a first intensity-modulated optical signal S9A generated by intensity-modulating the first split optical signal S8A based on the input first driving signal. Each of the first and second IMs 280 and 290 may be a LiNbO₃ Mach-Zehnder modulator.

The second IM 290 includes first and second arms 292 and 294 coupled to each other at both ends and an electrode 296 for supplying the second driving signal First end of the second IM 290 is connected to the third port of the first OC 270 and second end is connected to a third port of the second OC 300. The second IM 290 inputs the second split optical signal S8B from the first OC 270 and outputs a second intensity-modulated optical signal S9B generated by intensity-modulating the second split optical signal S8B based on the input second driving signal.

The second OC 300 includes a root waveguide 302 coupled to first and second branch waveguides 304 and 306 that branch off in two directions from the root waveguide 302, an electrode 308, and first to third ports. The electrode is deployed between the first and second branch waveguides 304 and 306r and provides label data. The first port is coupled to the optical fiber 205, the second port is coupled to the first IM 280, and the third port is coupled to the second IM 290.

The second OC 300 controls a phase difference between the first intensity-modulated optical signal S9A passing through the first branch waveguide 304 and the second intensity-modulated optical signal S9B passing through the second branch waveguide 306 based on the label data. Thereafter, the second OC 300 outputs an FSK-modulated optical signal S10 generated by coupling the two phase-controlled optical signals. The label data has a lower frequency than the intermediate frequency fm of the payload data. The FSK-modulated optical signal S10 represents every “1” bit of the label data as the first frequency f1 and every “0” bit of the label data as the second frequency f2. In addition, since the FSK-modulated optical signal S5 is OOK-simulated, every “1” bit of the payload data is represented as the power of the “A” level, and every “0” bit of the payload data is represented as the power of the “B” level.

Returning to FIG. 1, the NODE-E 330 includes an OC 340, a BPF 350 and first and second optical detectors 360 and 370.

The OC 340 has first to third ports, where the first port is coupled to the optical fiber 205, the second port is coupled to the BPF 350, and the third port is coupled to the second optical detector 370. The OC 340 power-splits the FSK-modulated optical signal S10 input from the first port (generates first and second split optical signals S11A and S11B) and outputs the power-split first and second split optical signals S11A and S11B to the second and third ports, respectively.

The BPF 350, which is connected to the second port of the OC 340, converts a frequency component of the FSK-modulated first split optical signal S11A to an amplitude component. That is, a first frequency of the first split optical signal S11A is converted to a power of a “C” level, and a second frequency is represented as a power of a “D” level.

The first optical detector 360 detects an amplitude-converted first split optical signal S12 passed through the BPF 350 as an electrical signal and demodulates the label data from the electrical signal.

The second optical detector 370, which is connected to the third port of the OC 340, detects the input second split optical signal S11B as an electrical signal and demodulates the payload data from the electrical signal.

As described above, according to a label remover, a method using the label remover, a label swapper, and a method using the label swapper according to the embodiment of the present invention, photoelectric conversion becomes unnecessary. The present invention renders the conversion unnecessary by removing label data through a process of double-side-band-converting an input FSK-modulated optical signal. Since a non-linear effect of an SOA is not used, using conditions and transmission quality are improved compared to prior arts.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A label removing method comprising the steps of:
(a) receiving an optical signal modulated based on a data signal of an intermediate frequency fm and frequency-modulated based on a label signal so as to provide a first frequency f1 and a second frequency f2;
(b) frequency-transiting the received optical signal so that each of the first and second frequencies is transited to at least two frequencies including the intermediate frequency fm; and
(c) filtering the frequency-transited optical signal to remove the first and second frequencies except the intermediate frequency fm.

2. The method of claim 1, wherein the intermediate frequency fm corresponds to (f1+f2)/2.

3. The method of claim 2, wherein in the step (b), the first frequency f1 is transited to frequencies (f1−f3) and (f1+f3), and the second frequency f2 is transited to frequencies (f2−f3) and (f2+f3), and wherein a third frequency f3 corresponds to a half of a difference between the first and second frequencies (f1−f2)/2.

4. The method of claim 1, wherein in the step (c), the filtered frequency is the intermediate frequency fm.

5. A label swapping method comprising the steps of:
(a) receiving an optical signal modulated based on a data signal of an intermediate frequency and frequency-modulated based on a label signal so as to provide a first frequency f1 and a second frequency f2;
(b) frequency-transiting the received optical signal so that each of the first and second frequencies is transited to at least two frequencies including the intermediate frequency;
(c) filtering the frequency-transited optical signal to remove the first and second frequencies except the intermediate frequency; and
(d) modulating the filtered optical signal based on the data signal of the intermediate frequency and frequency-modulating the modulated optical signal based on a new label signal so as to provide the first frequency f1 or the second frequency f2.

6. The method of claim 5, wherein the intermediate frequency fm corresponds to (f1+f2)/2

7. The method of claim 6, wherein in the step (b), the first frequency f1 is transited to frequencies (f1−f3) and (f1+f3), and the second frequency f2 is transited to frequencies (f2−f3) and (f2+f3), and wherein a third frequency f3 corresponds to a half of a difference between the first and second frequencies (f1−f2)/2.

8. The method of claim 5, wherein in the step (c), the filtered frequency is the intermediate frequency.

9. An optical network system for transmitting an optical signal using a label swapping, comprising:
a first modulator for modulating the optical signal based on a data signal of an intermediate frequency fm and frequency-modulating based on a label signal to provide a first frequency f1 and a second frequency f2;
a label swapper for frequency-transiting the optical signal so that each of the first and second frequencies is transited to at least two frequencies including the intermediate frequency; and
a filter for filtering the frequency-transited optical signal to remove the first and second frequencies except the intermediate frequency.

10. The optical network system of claim 9, further comprising a second modulator for the filtered optical signal based on the data signal of the intermediate frequency fm and frequency-modulating the second modulated optical signal based on the label signal so as to provide the first frequency f1 or the second frequency f2.

11. The optical network system of claim 9, wherein the label data has a lower frequency than the intermediate frequency fm.

12. The optical network system of claim 9, wherein the intermediate frequency fm corresponds to (f1+f2)/2.

13. The optical network system of claim 9, wherein the first frequency f1 is transited to frequencies (f1−f3) and (f1+f3), and the second frequency f2 is transited to frequencies (f2−f3) and (f2+f3), and wherein a third frequency f3 corresponds to a half of a difference between the first and second frequencies (f1−f2)/2.

14. The optical network system of claim 9, wherein the filtered frequency is the intermediate frequency fm.
